(19) United States
(12) Patent Application Publication
(10) Pub. No.: US 2014/0208215 A1
(43) Pub. Date: Jul. 24, 2014

(54) METHODS AND SYSTEMS FOR PROVIDING FILTERED REPORT VISUALIZATIONS

(71) Applicant: salesforce.com, inc., San Francisco, CA (US)

(72) Inventor: Suyog Deshpande, San Francisco, CA (US)

(73) Assignee: salesforce.com, inc., San Francisco, CA (US)

(21) Appl. No.: 14/069,172

(22) Filed: Oct. 31, 2013

Related U.S. Application Data
(60) Provisional application No. 61/754,842, filed on Jan. 21, 2013.

(51) Int. Cl. G06F 3/0484

(52) U.S. Cl. CPC G06F 3/0484
USPC 715/736

(57) ABSTRACT

Methods and systems are provided for providing report visualizations in an on-demand system providing instances of a virtual application over a network. One exemplary method involves identifying a filter associated with a user of a client device on the network and automatically providing one or more filtered report visualizations within an instance of the virtual application on the client device in response to identifying the filter associated with the user. Each visualization of the one or more filtered report visualizations comprises a graphical representation of a filtered subset of report data that satisfies the identified filter that is associated with the user.

### CROSS-REFERENCE TO RELATED APPLICATION(S)

This application claims the benefit of U.S. provisional patent application Ser. No. 61/754,842, filed Jan. 21, 2013, the entire content of which is incorporated by reference herein.

### TECHNICAL FIELD

Embodiments of the subject matter described herein relate generally to computer systems, and more particularly, to methods and systems for providing filtered report visualizations in an on-demand computing system.

### BACKGROUND

Modern software development is evolving away from the client-server model toward network-based processing systems that provide access to data and services via the Internet or other networks. In contrast to traditional systems that host networked applications on dedicated server hardware, a “cloud” computing model allows applications to be provided over the network “as a service” or “on-demand” by an infrastructure provider. The infrastructure provider typically abstracts the underlying hardware and other resources used to deliver a customer-developed application so that the customer no longer needs to operate and support dedicated server hardware. The cloud computing model can often provide substantial cost savings to the customer over the life of the application because the customer no longer needs to provide dedicated network infrastructure, electrical and temperature controls, physical security and other logistics in support of dedicated server hardware.

Multi-tenant cloud-based architectures have been developed to improve collaboration, integration, and community-based cooperation between customer tenants without sacrificing data security. Generally speaking, multi-tenancy refers to a system where a single hardware and software platform simultaneously supports multiple user groups (also referred to as “organizations” or “tenants”) from a common data storage element (also referred to as a “multi-tenant database”). The multi-tenant design provides a number of advantages over conventional server virtualization systems. First, the multi-tenant platform operator can often make improvements to the platform based upon collective information from the entire tenant community. Additionally, because all users in the multi-tenant environment execute applications within a common processing space, it is relatively easy to grant or deny access to specific sets of data for any user within the multi-tenant platform, thereby improving collaboration and integration between applications and the data managed by the various applications. The multi-tenant architecture therefore allows convenient and cost effective sharing of similar application features between multiple sets of users. For example, a multi-tenant system may support an on-demand customer relationship management (CRM) application that manages the data for a particular organization's sales staff that is maintained by the multi-tenant system and facilitates collaboration among members of that organization's sales staff (e.g., account executives, sales representatives, and the like).

In a CRM application, it is often desirable to provide reports, summaries or other visualizations of an organization's data to users belonging to or otherwise affiliated with that organization. For example, a set of charts, graphs, or other visual summaries indicating the statuses of various opportunities belonging to an organization may be provided to all of the sales representatives within the organization. However, not all of the data in those reports or summaries may be relevant to all of the sales representatives in the organization. Accordingly, a user may apply filters to try and limit the scope of the visualizations to only the data that is relevant to that particular user. However, manually defining filters and applying the filters each time a filter is defined or modified may be time consuming and may also undesirably consume computing resources.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a block diagram of an exemplary on-demand application system;

FIG. 2 is a flow diagram of an exemplary filter definition process suitable for implementation by the on-demand application system of FIG. 1 in accordance with one or more embodiments;

FIGS. 3-4 illustrate exemplary graphical user interface displays that may be presented within a virtual application on a client device in the on-demand application system of FIG. 1 in connection with the filter definition process of FIG. 2 in accordance with one or more exemplary embodiments;

FIGS. 5-6 illustrate an exemplary sequence of graphical user interface elements that may be presented within the graphical user interface display of FIG. 3 in accordance with one or more exemplary embodiments;

FIG. 7 is a flow diagram of an exemplary dashboard generation process suitable for implementation by the on-demand application system of FIG. 1 in accordance with one or more embodiments; and

FIG. 8 is a block diagram of an exemplary multi-tenant system suitable for use as the on-demand application system of FIG. 1 in accordance with one or more embodiments.

### DETAILED DESCRIPTION

Embodiments of the subject matter described herein generally relate to methods and systems for providing filtered report visualizations in an on-demand system that are generated based on one or more filtering criteria defined by a user. In this regard, a report visualization is a graphical representation of report data that is determined, calculated, or otherwise generated based on data associated with one or more objects maintained in a database of the on-demand system. For example, in a customer relationship management (CRM) application, the on-demand system may maintain a plurality of account objects corresponding to the accounts associated with or otherwise belonging to a particular organization, wherein the account data associated with one or more of those plurality of account objects is processed or otherwise manipulated to generate report data based on one or more of those account objects. The report data may also be maintained in the database of the on-demand system and utilized to generate one or more graphical representations of the report data (or a subset thereof), such as, for example, charts, graphs, tables, or the like. In exemplary embodiments described herein, a set of report visualizations are provided within a dashboard graphical user interface (GUI) display, wherein the database of the on-demand system maintains a dashboard object that identifies or otherwise defines the types of report visualizations to be included on or within the dashboard GUI display along with the particular report data (or subset thereof) to be utilized to generate a respective report visualization.

As described in greater detail below, one or more GUI elements are provided that allow a user to select or otherwise identify one or more filtering criteria for a filter that the user would like to be applied to generate the visualizations of one or more reports associated with the user and/or the user's tenant that are presented within the dashboard GUI display. The filtering criteria are utilized to exclude at least a portion of the source report data used to generate a particular report visualization on the dashboard GUI display and obtain a filtered subset of the report data that satisfies the filtering criteria. Thereafter, the report visualization(s) on the dashboard GUI display are generated based on the filtered subset of the report data, for example, by generating the type of graphical representation indicated by the dashboard object using the filtered subset of report data. In this manner, when a filter is applied to the dashboard GUI display, the resulting report visualizations presented in the dashboard GUI display are representative of filtered subsets of the source report data that would otherwise be used to generate the report visualizations if the filter were not applied. For purposes of explanation, a report visualization generated based on a filtered subset of report data may alternatively be referred to herein as a filtered report visualization.

In exemplary embodiments described herein, the dashboard filter and the corresponding filtered report visualizations are stored in the database of the on-demand system in association with the user for subsequent presentation to the user. For example, the filter may be associated with the user's dashboard GUI display (e.g., in response to the user designating the set of filtering criteria as a default dashboard filter) so that after logging out of the on-demand system, when the user logs back in to the on-demand system to view his or her dashboard, the stored filtered report visualizations corresponding to that dashboard filter are automatically presented in the dashboard GUI display. In this regard, computing resources of the on-demand system need not be utilized for re-applying the dashboard filter to the source report data and regenerating the filtered report visualizations each time the user logs back in to the on-demand system or otherwise attempts to view his or her dashboard.

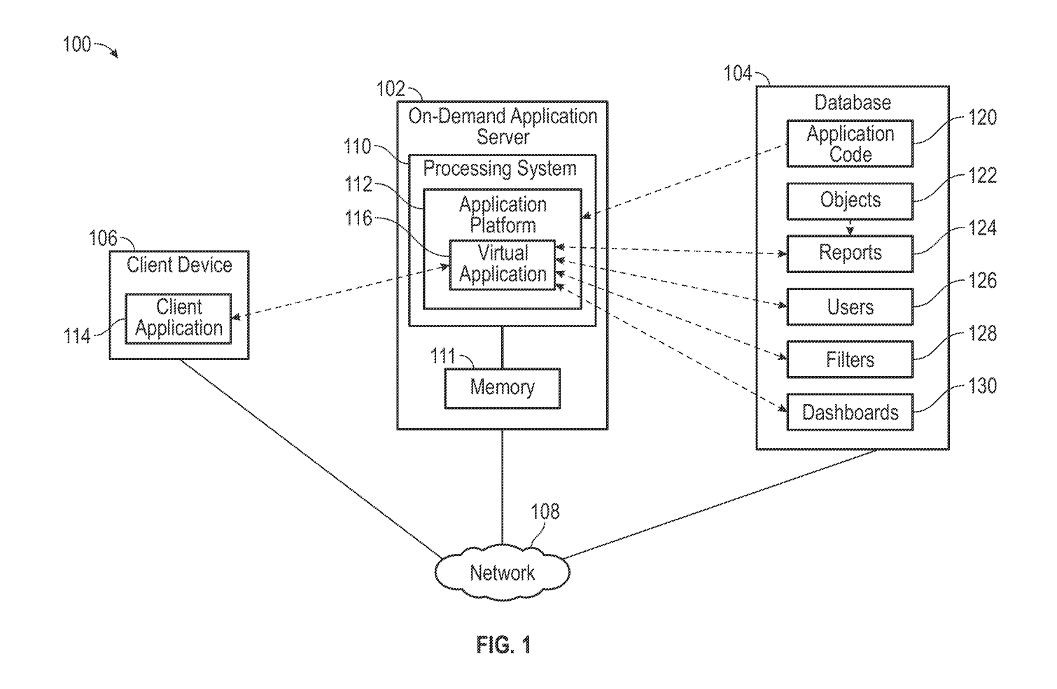

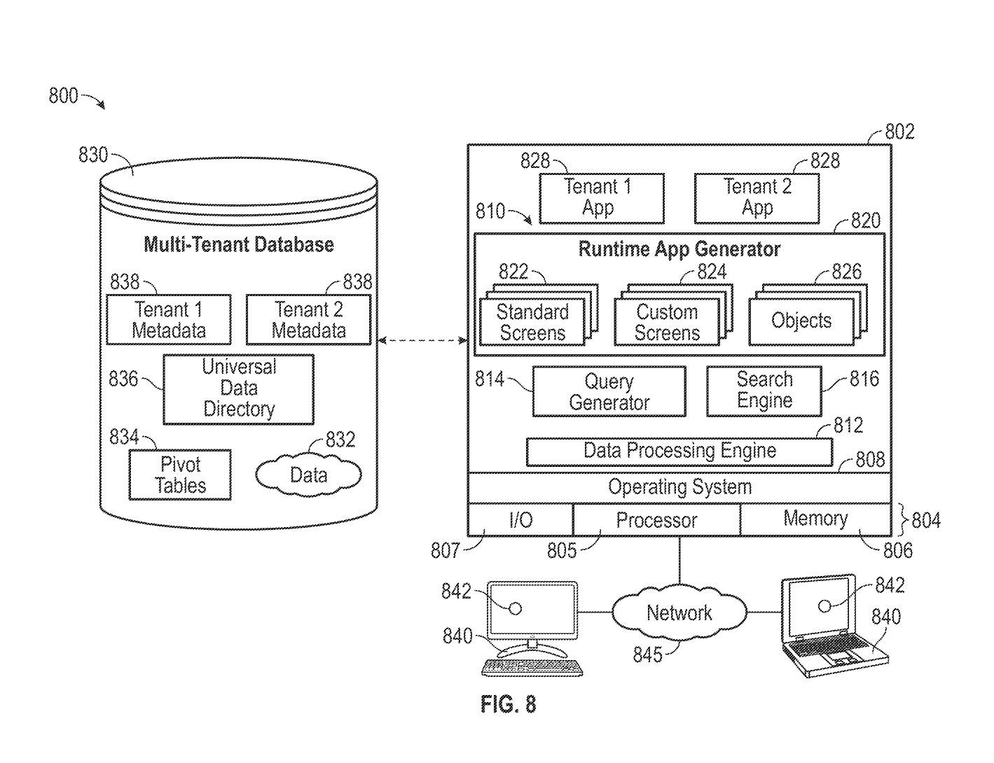

Turning now to FIG. 1, an exemplary on-demand application system 100 includes an application server 102 that includes or otherwise implements an application platform 112 capable of generating one or more instances of a virtual application 116 at run-time (or “on-demand”) based upon data stored or otherwise maintained by a database 104 that is communicatively coupled to the application server 102 via a communications network 108, such as a wired and/or wireless computer network, a cellular network, a mobile broadband network, a radio network, or the like. In this regard, the application server 102 and the database 104 cooperatively provide a cloud computing platform (or framework). In accordance with one or more embodiments, the database 104 is realized as a multi-tenant database that is shared between multiple tenants, with each tenant having its own set of associated users. In this regard, the database 104 may store or otherwise maintain data associated with a number of different tenants and restrict accessibility of one tenant's data with respect to other tenants' data, as described in greater detail below in the context of FIG. 8.

In the illustrated embodiment of FIG. 1, the application server 102 generally represents a computing system or another combination of processing logic, circuitry, hardware, and/or other components configured to support the record management processes, tasks, operations, and/or functions described herein. In this regard, the application server 102 includes a processing system 110, which may be implemented using any suitable processing system and/or device, such as, for example, one or more processors, central processing units (CPUs), controllers, microprocessors, microcontrollers, processing cores and/or other hardware computing resources configured to support the operation of the processing system 110 described herein. The processing system 110 may include or otherwise access a data storage element 111 (or memory) capable of storing programming instructions for execution by the processing system 110, that, when read and executed, cause processing system 110 to create, generate, or otherwise facilitate the application platform 112 that generates or otherwise provides instances of the virtual application 116 at run-time (or “on-demand”) based upon data and/or code 120 that is stored or otherwise maintained by the database 104. Depending on the embodiment, the memory 111 may be realized as a random access memory (RAM), read only memory (ROM), flash memory, magnetic or optical mass storage, or any other suitable non-transitory short or long term data storage or other computer-readable media, and/or any suitable combination thereof.

In exemplary embodiments, an instance of the virtual application 116 is provided to a client device 106 that is communicatively coupled to the application server 102 via a communications network, such as network 108. In this regard, the client device 106 generally represents an electronic device coupled to the network 108 that is utilized by a user to access the application platform 112 and/or virtual application 116 on the application server 102. In practice, the client device 106 can be realized as any sort of personal computer, mobile telephone, tablet or other network-enabled electronic device that includes a display device, such as a monitor, screen, or another conventional electronic display, capable of graphically presenting data and/or information provided by the application platform 112 and/or the virtual application 116 along with a user input device, such as a keyboard, a mouse, a touchscreen, or the like, capable of receiving input data and/or other information from the user of the client device 106.

A user may manipulate the client device 106 to execute a client application 114, such as a web browser application, and contact the application server 102 and/or application platform 112 using a networking protocol, such as the hypertext transport protocol (HTTP) or the like. In response, the application server 102 and/or application platform 112 accesses the database 104 to obtain or otherwise retrieve application code 120, which includes computer-executable code segments, instructions, scripts or the like that are executed by the processing system 110 and/or application platform 112 to generate the virtual application 116. In response to receiving login information from the user of the client device 106, the application platform 112 authenticates or otherwise identifies the user and generates the virtual application 116 at run-time based upon information and/or data maintained by the database 104 that is associated with the user and/or the user's associated tenant. The virtual application 116 may include code, data and/or other dynamic web content provided to the client device 106 that is parsed, executed or otherwise presented by the client application 114 running on the client device 106. In an exemplary embodiment, the virtual application 116 is a virtual customer relationship management (CRM) application.

Still referring to FIG. 1, in exemplary embodiments, the database 104 includes or otherwise maintains a plurality of object tables 122 that correspond to the different types of objects available to the user of the client device 106 within the virtual application 116. In general, an object is a data structure that maintains a logical association among data values and is utilized by the virtual application 116 to generate GUI displays and provide other features and/or functionality for the virtual application 116. For example, the database 104 may maintain standard objects available to all users and/or tenants within the on-demand system 100 (e.g., “account,” “opportunity,” “contact” objects, and the like in a CRM application) and custom objects that are available only to particular users and/or particular tenants within the on-demand system 100. Each object table 122 includes a plurality of columns that correspond to the respective fields of the object type associated with that respective object table 122, with each row (or record or entry) in a respective object table 122 corresponding to a respective instance of that type of object. For example, an object table 122 associated with the “account” object type includes columns corresponding to the account object fields, with each row (or entry) in the account object table 122 corresponding to a different account and having values for the columns of that respective row that correspond to the respective account object fields of that respective account. Additionally, in multi-tenant implementations, each object table 122 includes a column that corresponds to the tenant identifier, with each record in a respective object table 122 including the tenant identifier for the tenant associated with that particular instance of that type of object.

The database 104 also includes or otherwise maintains a report table 124 where each entry in the report table 124 includes data and/or values for a report generated based on one or more objects from the object tables 122. For example, an entry (or row) in the report table 124 may correspond to a sales report associated with a particular tenant in the on-demand system 100, wherein the columns of that entry in the report table 124 include data values that calculated or otherwise generated based on data obtained from the opportunity objects associated with that tenant that are maintained in the opportunity object table 122. In this regard, in multi-tenant implementations, each entry in the report table 124 may also include a column having a value equal to the tenant identifier associated with the report.

In the illustrated embodiment, the database 104 also includes a user table 126, where each entry in a user table 126 maintains an association between a particular user in the on-demand system 100 and other settings and/or preferences for that user. Additionally, in multi-tenant implementations, each entry in user table 126 may include a column having a value equal to the tenant identifier associated with the user's tenant. For example, each row (or entry) in the user table 126 may include a first column having a value equal to an identifier associated with the user (e.g., a UserID), a second column having a value equal to an identifier associated with the user's tenant (e.g., an OrgID), and one or more additional columns having values indicative of that user's settings and/or preferences. In one or more exemplary embodiments described herein, the user table 126 includes one or more columns having values indicative of a default dashboard filter that the user would like to associate with a dashboard GUI display within the virtual application 116. For example, the user table 126 may include a default dashboard filter column having a value equal to a filter identifier associated with a dashboard filter previously defined by the user. In this regard, the illustrated database 104 also includes a filter table 128 that maintains an association between the filter identifier associated with a visualization filter and one or more filtering criteria for that filter that have been previously defined by a user in the on-demand system 100.

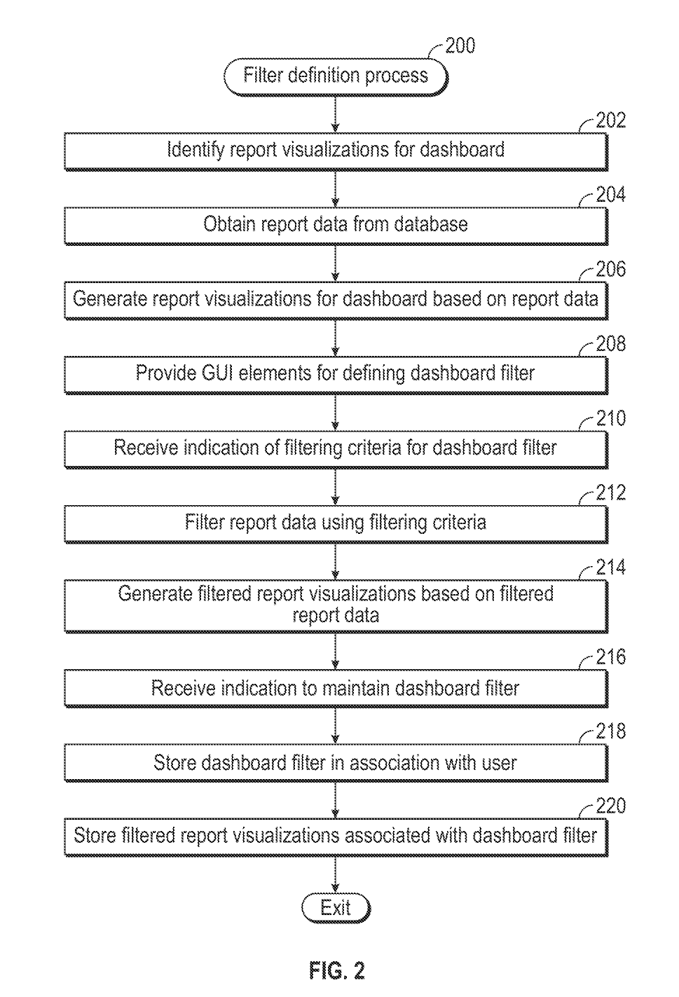

As described in greater detail below in the context of FIGS. 2-7, the virtual application 116 includes a dashboard GUI display generated by the application platform 112 based on data obtained from the database 104. The dashboard GUI display includes one or more report visualizations generated based on report data obtained from one or more report objects maintained in the report table 124. In this regard, a report visualization is a graphical representation of data obtained from a report object in the report table 124, such as, for example, a pie chart, a bar chart, a line chart, a donut chart, a funnel chart, a gauge chart, a table, or the like.

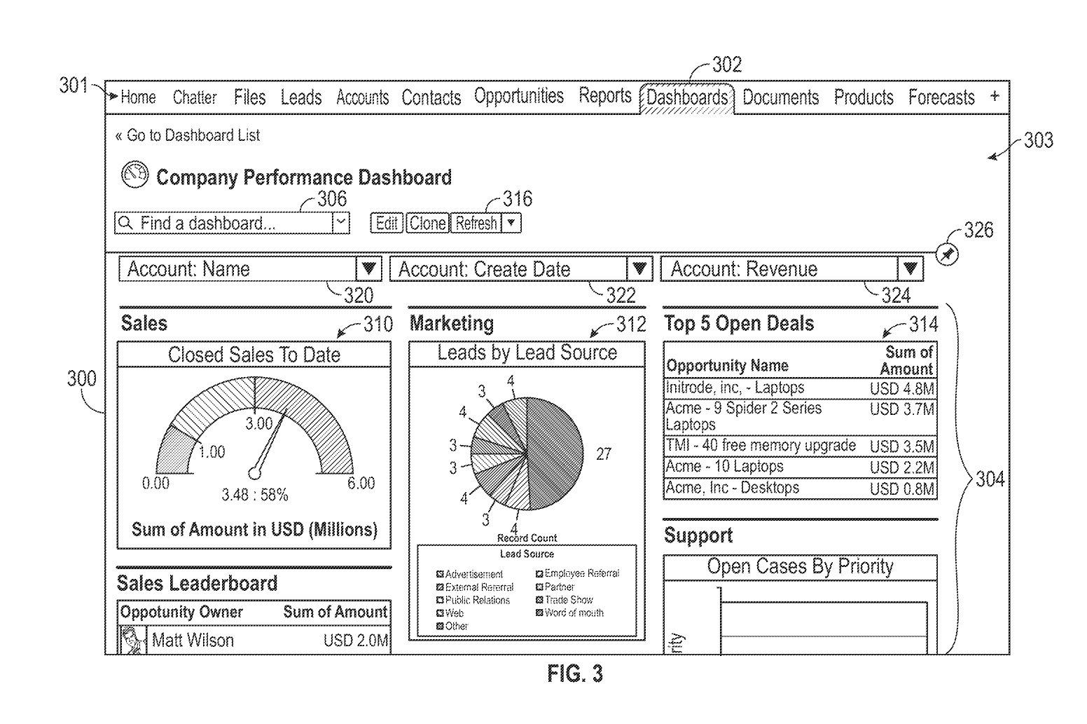

In exemplary embodiments, the database 104 includes a dashboard table 130 that maintains an association between a dashboard GUI display and the one or more report visualizations associated with that dashboard GUI display. In this regard, in one or more exemplary embodiments, an administrator associated with a tenant may define the report visualizations associated with a particular dashboard GUI display that is presented to users associated with that tenant. For example, as illustrated in FIG. 3, a dashboard object in the dashboard table 130 for a company performance dashboard associated with a particular tenant may indicate the company performance dashboard GUI display presented to that tenant's users should include a gauge chart 310 representative of first source report data obtained from a sales report object in the report table 124 (e.g., a closed sales gauge chart 310 representative of closed sales data obtained from a sales report), a pie chart 312 representative of second source report data obtained from a marketing report object in the report table 124, and a table 314 representative of third source report data obtained from an opportunity report object in the report table 124. Thus, the dashboard table 130 maintains an association a particular dashboard GUI display and the number, type and/or content of the report visualizations displayed or otherwise contained therein.

As described in greater detail below in the context of FIGS. 2-6, in exemplary embodiments, the dashboard GUI display includes GUI elements that allow a user to define one or more filtering criteria for a dashboard filter to be applied to that dashboard. After one or more of the GUI elements are manipulated to define the filtering criteria for the dashboard filter, the virtual application 116 applies the filtering criteria to report data obtained from the report table 124 to obtain a filtered subset of report data, which, in turn, is utilized by the virtual application 116 to generate filtered versions of the report visualizations associated with the dashboard based on the filtered subset of report data. In exemplary embodiments, the filtering criteria are applied to the source report data for each of the report visualizations within the dashboard GUI display, so that the dashboard filter is applied to all of the report visualizations on the dashboard.

The dashboard GUI display also includes GUI elements adapted to allow a user to indicate a desire to save, store, persist or otherwise maintain the dashboard filter in the on-demand application system 100. In response to receiving an indication of a desire to save, store, or otherwise maintain the dashboard filter, the application platform 112 and/or the virtual application 116 may create an entry in the filter table 128 that maintains an association between the user's identifier and the filtering criteria defined by the user for that dashboard filter being persisted. Additionally, in exemplary embodiments, the application platform 112 and/or the virtual application 116 creates an entry in the dashboard table 130 that maintains an association between the user identifier, the filter identifier associated with the entry in the filter table 128, and the filtered report visualizations generated based on the filtered report data satisfying the filtering criteria of the filter. In this regard, in some embodiments, the user may manipulate one or more GUI elements to select a stored dashboard filter (e.g., a particular filter from among a plurality of dashboard filters that the user has defined) to be applied to a currently presented dashboard GUI display. In response to receiving the selection, the virtual application 116 utilizes the user's identifier and the filter identifier associated with the selected dashboard filter to obtain the stored filtered visualizations for that dashboard filter from the dashboard table 130 and automatically provide the stored filtered visualizations within the dashboard GUI display.

Additionally, in some embodiments, the user may also designate a dashboard filter as a default filter to be pinned to the dashboard GUI display or otherwise applied to the user's dashboards. For example, when the user attempts to view the dashboard GUI display after logging in to the virtual application 116, the application platform 112 and/or the virtual application 116 may utilize the user's identifier to access the user table 126 and identify the current default dashboard filter associated with the user, utilize the filter identifier associated with the identified default dashboard filter to obtain the corresponding filtered report visualizations stored by the database 104, and automatically provide the filtered report visualizations associated with the default dashboard filter within the dashboard GUI display. Thus, the user does not need to manually redefine and/or reapply the desired default dashboard filter when the user logs back in to the virtual application 116 after previously logging out of the virtual application 116 or when the user reverts to the dashboard GUI display from other GUI displays presented within the virtual application 116. For example, as described in greater detail below, the virtual application 116 may include a tabbed interface display including a dashboards tab, where the user may select tabs other than the dashboards tab to view other GUI displays within the virtual application 116. Thereafter, when the user selects the dashboard tab to revert to the dashboard GUI display, the application platform 112 and/or the virtual application 116 may automatically provide the filtered report visualizations associated with the default dashboard filter within the dashboard GUI display.

In exemplary embodiments, when the user selects a particular dashboard from a list of dashboards defined for the user's tenant, the virtual application 116 utilizes the user's identifier and the filter identifier associated with the default dashboard filter to obtain the filtering criteria associated with the default dashboard filter from the filter table 128 and automatically filter the source report data obtained from the report table 124, generate the filtered visualizations, and provide the filtered report visualizations within the dashboard GUI display. Thus, the user does not need to manually redefine and/or reapply the desired default dashboard filter when selecting and viewing various different dashboards.

In accordance with one or more exemplary embodiments, in response to the user manipulating, modifying, or otherwise changing one or more of the filtering criteria associated with the currently applied dashboard filter and indicating a desire to apply the modified filtering criteria and/or store the modified criteria in association with the currently applied dashboard filter, the virtual application 116 automatically filters the source report data obtained from the report table 124 using the modified filtering criteria, generates updated filtered report visualizations, provides the updated filtered report visualizations within the dashboard GUI display, and also overwrites or otherwise stores the modified filtering criteria in the filter table 128 in association with the filter identifier associated with the current dashboard filter. Additionally, the application platform 112 and/or the virtual application 116 may update the entry in the dashboard table 130 that maintains an association between the user identifier and the filter identifier associated the currently applied dashboard filter to include the updated filtered report visualizations. For example, in response to the user modifying one or more filtering criteria for a default dashboard filter, the virtual application 116 may automatically filter the source report data obtained from the report table 124 using the modified filtering criteria to provide updated filtered report visualizations within the dashboard GUI display, store the modified filtering criteria in association with the user's default dashboard filter in the filter table 128, and store the updated filtered report visualizations in the entry in the dashboard table 130 that maintains an association between the user identifier and the default dashboard filter.

It should be understood that FIG. 1 is a simplified representation of an on-demand application system provided for purposes of explanation and is not intended to limit the subject matter described herein. Although FIG. 1 depicts the client device 106 communicating on the same network 108 that the application server 102 and the database 104 communicate on, in practice, the client device 106 and the application server 102 may communicate via a communications network that is separate and/or distinct from the network 108. For example, the client device 106 could communicate with the application server 102 via a cellular network or the Internet, while the application server 102 communicates with the database 104 via a local area network (LAN).

FIG. 2 depicts an exemplary embodiment of a filter definition process 200 suitable for implementation by an on-demand application system to allow a user to define a dashboard filter by designating one or more filtering criteria subsequently used to generate visualizations based on filtered report data. The various tasks performed in connection with the illustrated process 200 may be performed by software, hardware, firmware, or any combination thereof. For illustrative purposes, the following description may refer to elements mentioned above in connection with FIG. 1. In practice, portions of the filter definition process 200 may be performed by different elements of the on-demand application system 100, such as, for example, the application server 102, the database 104, the processing system 110, the application platform 112, the virtual application 116, and/or the application code 120. It should be appreciated that the filter definition process 200 may include any number of additional or alternative tasks, the tasks need not be performed in the illustrated order and/or the tasks may be performed concurrently, and/or the filter definition process 200 may be incorporated into a more comprehensive procedure or process having additional functionality not described in detail herein. Moreover, one or more of the tasks shown and described in the context of FIG. 2 could be omitted from a practical embodiment of the filter definition process 200 as long as the intended overall functionality remains intact.

Referring now to FIGS. 1-2, in an exemplary embodiment, the filter definition process 200 begins by presenting or otherwise providing a dashboard GUI display within the virtual application 116 on the client device 106 of the user that defines the dashboard filter, wherein the dashboard GUI display includes GUI elements that allow the user to define one or more filtering criteria for a dashboard filter. In this regard, the illustrated filter definition process 200 identifies or otherwise determines the report visualizations to be presented within the dashboard GUI display, retrieves or otherwise obtains the report data for generating those visualizations from the database, and generates or otherwise provides the report visualizations based on the obtained report data within the dashboard GUI display (tasks 202, 204, 206). Additionally, the filter definition process 200 generates or otherwise provides GUI elements within the dashboard GUI display that allow the user to select, identify, or otherwise define one or more filtering criteria for a dashboard filter (task 208).

Referring to FIG. 3, and with continued reference to FIGS. 1-2, in an exemplary embodiment, the application platform 112 generates or otherwise executes the virtual application 116 and provides the virtual application 116 to the client device 106 by presenting or otherwise displaying a tabbed graphical user interface display 300 within the client application 114. The tabbed interface display 300 includes a tab menu region 301 that includes a set of tabs associated with the various different types of objects supported by the object tables 122 in the database 104 (e.g., “Files,” “Leads,” “Accounts,” “Contacts,” “Opportunities,” or the like) along with a tab associated with the report objects in the report table 124, that, when selected, result in the virtual application 116 presenting a GUI display beneath the tab menu 301 based on data obtained from objects in the particular object table 122, 124 corresponding to the selected object type that are associated with the user of the client device 106 and/or the user's tenant. Additionally, the tab menu 301 includes a dashboard tab 302, and in response to the user of the client device 106 selecting the dashboard tab 302, the application platform 112 and/or virtual application 116 provides a dashboard GUI display 304 within a dashboard display region 303 of the tabbed interface display 300 that includes a plurality of report visualizations generated based on the report data obtained from the report table 124. In various embodiments, the application platform 112 and/or virtual application 116 accesses the user table 126 and/or the dashboard table 130 to identify the set of report visualizations to be presented within the display region 303 (e.g., a default dashboard defined by an administrator associated with the user's tenant).

In some embodiments, the application platform 112 and/or virtual application 116 accesses the report table 124 to obtain source report data needed to generate the identified set of report visualizations, generates the corresponding graphical representations of the source report data, and provides the generated report visualizations within the display region 303. For example, as illustrated, the application platform 112 and/or virtual application 116 may generate a gauge GUI element 310 based on sales report data obtained from the report table 124, a pie chart GUI element 312 based on leads report data obtained from one or more marketing report objects in the report table 124, and a table 314 based on opportunity report data obtained from one or more opportunity report objects in the report table 124. In other embodiments, the report data in the report table 124 is previously generated or otherwise determined based on object data from the object table 122. For example, the opportunity report data used to generate the table 314 may be previously generated based on data maintained in the opportunity object table 122 for opportunity objects associated with the user's tenant and stored in the corresponding opportunity report object in the report table 124 prior to the user logging in to the virtual application 116 and/or activating the dashboard tab 302.

After the report visualizations for a particular dashboard have been generated, the application platform 112 and/or virtual application 116 may store the report visualizations in the dashboard table 130 in association with the dashboard for subsequent retrieval. Accordingly, in embodiments where the set of report visualizations for the dashboard to be presented in the display region 303 have already been generated, the application platform 112 and/or virtual application 116 may automatically populate the dashboard GUI display 304 using the stored report visualizations from the dashboard table 130 that are associated with the identified dashboard. As illustrated, the dashboard GUI display 304 may include a GUI element 316 that a user may manipulate to update or otherwise refresh the report visualizations, wherein in response to the user selecting the GUI element 316, the application platform 112 and/or virtual application 116 accesses the report table 124 to obtain source report data (which may or may not have been updated since the stored report visualizations were generated), generates updated graphical representations based on the more recently obtained report data, provides the updated report visualizations within the display region 303, and stores the updated report visualizations in the database 104 (e.g., by overwriting the stored visualizations based on older report data).

Still referring to FIG. 3, the application platform 112 and/or virtual application 116 generates or otherwise provides GUI elements 320, 322, 324, 326 within the dashboard GUI display 304 that may be manipulated by the user of the client device 106 to select, identify, or otherwise define one or more filtering criteria for a dashboard filter and store or otherwise maintain the dashboard filter within the on-demand application system 100. For example, the dashboard GUI display 304 may include drop-down menus 320, 322, 324 that allow the user to select one of a number of possible filtering criteria for a dashboard filter and a button 326 that may be manipulated by the user to store or otherwise maintain the filtering criteria for the dashboard filter in the filter table 128 in the database 104. Additionally, in some embodiments, the GUI element 326 for maintaining the dashboard filter in the database 104 may be adapted to allow the user to designate the stored dashboard filter as a default dashboard filter associated with the user, as described in greater detail below.

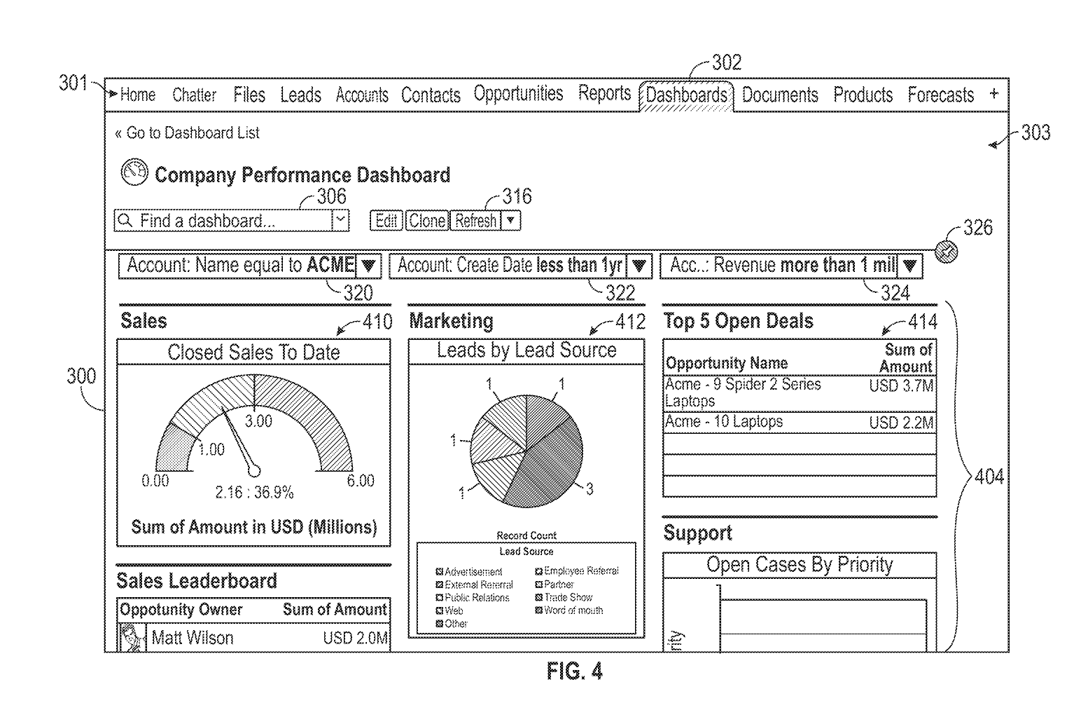

Referring again to FIG. 2, and with continued reference to FIGS. 1-3, the filter definition process 200 continues by receiving input indicative of one or more desired filtering criteria for a dashboard filter, filtering or otherwise limiting the source report data utilized to generate the report visualizations in the dashboard based on the identified filtering criteria, and generating or otherwise providing filtered report visualizations based on the filtered subset of the source report data within the dashboard GUI display (tasks 210, 212, 214). In this regard, the user of the client device 106 may manipulate the first filtering criteria drop-down menu 320 to select or otherwise identify a first filtering criterion that the user would like to apply to the report visualizations in the dashboard GUI display 304. For example, referring to FIG. 4, the user may manipulate the first filtering criteria drop-down menu 320 to indicate that the user would like to see report visualizations that only reflect report data associated with account objects having an account name equal to ‘ACME.’ In response, the application platform 112 and/or virtual application 116 may automatically filter or otherwise limit the source report data for the report visualizations to exclude any report data based on object data from the object tables 122 that is not associated with an account object having a name field equal to ‘ACME.’ Thus, the resulting filtered subset of report data only includes report data from the report table 124 that is generated or otherwise determined based on object data from the object tables 122 that is associated with an account object having a name field equal to ‘ACME.’ Thereafter, the application platform 112 and/or virtual application 116 may automatically generate graphical representations of the filtered subset of report data and provide the filtered report visualizations generated based on the filtered report data within the dashboard GUI display 304 in lieu of the original (or unfiltered) report visualizations.

In a similar manner, the application platform 112 and/or virtual application 116 may further filter the report data as the user continues to identify filtering criteria and update the report visualizations in the dashboard GUI display 304 accordingly. For example, in response to the user of the client device 106 manipulating the second filtering criteria drop-down menu 322 to indicate that the user would like to see report visualizations that only reflect report data associated with account objects having an account name equal to ‘ACME’ that were created within the last year, the application platform 112 and/or virtual application 116 may automatically filter the source report data to further exclude report data based on object data from the object tables 122 that is associated with an account object having a name field equal to ‘ACME’ that was created more than one year ago. Thus, the resulting filtered subset of report data only includes report data from the report table 124 that is generated or otherwise determined based on object data from the object tables 122 that is associated with an account object having a name field equal to ‘ACME’ that was created within the last year. Again, the application platform 112 and/or virtual application 116 automatically generates updated graphical representations of the filtered subset of report data and provide the filtered report visualizations generated based on the filtered report data associated with accounts created during the preceding year within the dashboard GUI display 304 in lieu of the previous filtered report visualizations.

As illustrated in FIG. 4, after the user manipulates the GUI elements 320, 322, 324 to designate filtering criteria for a dashboard filter, the application platform 112 and/or virtual application 116 generates or otherwise provides a filtered dashboard GUI display 404 within the display region 303 that includes filtered report visualizations 410, 412, 414 that correspond to the original (or unfiltered) report visualizations 310, 312, 314 but are generated based on a filtered subset of the report data in the report table 128. In this regard, for the illustrated embodiment, the filtered report visualizations 410, 412, 414 may be generated based solely on report data from the report table 124 that is based on object data from the object tables 122 associated with one or more account objects having a name field equal to ‘ACME’ that were created within the last year and have a revenue field with a value that is greater than one million. In other words, the filtered gauge chart 410 is representative of only the report data from the sales report object in the report table 124 that is associated with an account object having a name field equal to ‘ACME’ that was created within the last year and has a revenue field with a value that is greater than one million, the filtered pie chart 412 is representative of only the report data from the marketing report object in the report table 124 that is associated with an account object having a name field equal to ‘ACME’ that was created within the last year and has a revenue field with a value that is greater than one million, and so on.

Referring again to FIG. 2, in exemplary embodiments, the filter definition process 200 continues by receiving an indication of a desire to save, store, persist, or otherwise maintain the dashboard filter within the on-demand application system (task 216). For example, referring again to FIGS. 3-4, the user may select or otherwise manipulate a GUI element 326 within the dashboard GUI display 304 to provide an indication of a desire to pin, persist, or otherwise maintain the dashboard filter comprised of the filtering criteria identified by GUI elements 320, 322, 324 on the dashboard GUI display 304 as a default dashboard filter for the user. As illustrated in FIG. 4, in response to the user selecting the button 326 to indicate a desire to pin the filter to the user's dashboard, the button 326 and the filtering criteria indicated by the GUI elements 320, 322, 324 are displayed or otherwise rendered using a visually distinguishable characteristic relative to FIG. 3, such as, for example, boldface font. It will be appreciated that numerous different types and/or combinations of visually distinguishable characteristics are possible and could be used in practice, such as, for example, different types of font, different colors, outlining or otherwise highlighting the borders of the GUI elements 320, 322, 324, 326, and/or the like.

In response to receiving the indication to store, persist, or otherwise maintain the dashboard filter, the filter definition process 200 continues by storing or otherwise maintaining the association between dashboard filter and the user in the database (task 218). In one or more embodiments, in response to receiving the indication to pin the dashboard filter to the user's dashboard GUI display 304, the application platform 112 and/or virtual application 116 automatically updates the entry in the user table 126 that is associated with the user of the client device 106 to identify or otherwise indicate the dashboard filter comprised of the filtering criteria identified by GUI elements 320, 322, 324 is a default dashboard filter associated with the user, for example, by using a filter identification number associated with the dashboard filter and/or that set of filtering criteria in the filter table 128. In this regard, the application platform 112 and/or virtual application 116 may generate and/or assign a filter identifier for the dashboard filter and create an entry in the filter table 128 that stores or otherwise maintains the filtering criteria indicated by the GUI elements 320, 322, 324 in association with the filter identifier. The entry in the filter table 128 for the dashboard filter may also maintain an association between the filter identifier and a user identifier associated with the user of the client device 106 and/or a tenant identifier associated with the tenant associated with the user of the client device 106.

Still referring to FIGS. 1-4, in exemplary embodiments, the filter definition process 200 also stores or otherwise maintains the filtered report visualizations in association with the dashboard filter and the user (task 220). For example, in one or more embodiments, the application platform 112 and/or the virtual application 116 creates an entry for the user's default dashboard in the dashboard table 130 that includes the user identifier associated with the user of the client device 106, the filter identifier associated with the dashboard filter, and the corresponding filtered report visualizations that are presented within the dashboard GUI display 304. Accordingly, when a user logs out of the virtual application 116 and subsequently logs back in to the virtual application 116 and selects the dashboard tab 302, the application platform 112 and/or the virtual application 116 may access the user table 126, and based on the user's entry in the user table 126, automatically identify the default dashboard filter associated with the user and the corresponding dashboard entry in the dashboard table 130 that is associated with both the user's identifier and the filter identifier associated with the identified default dashboard filter. Thereafter, the application platform 112 and/or the virtual application 116 obtains the stored filtered report visualizations 410, 412, 414 from the dashboard table 130 and automatically provides the filtered dashboard GUI display 404 within the display region 303 whenever the user logs in to the virtual application 116 and the dashboard tab 302 is selected or otherwise activated. In alternative embodiments, the filtered report visualizations for the default dashboard filter may be stored or otherwise maintained in entry for the default dashboard filter in the filter table 128 or in the user's entry in the user table 126.

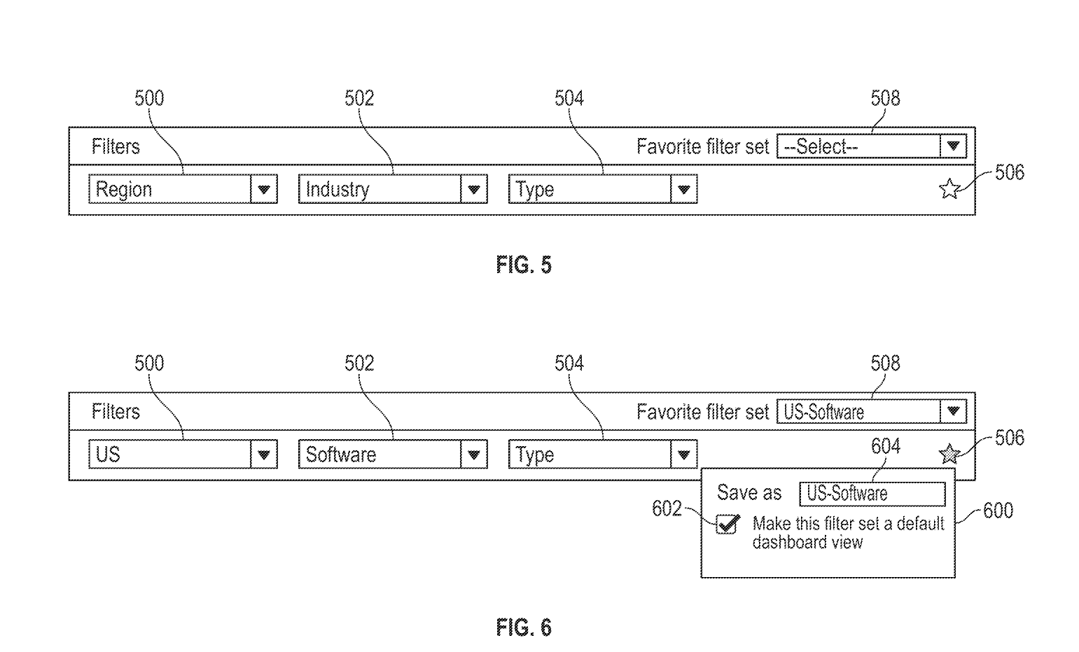

FIGS. 5-6 depict a sequence of GUI elements 500, 502, 504, 506, 508 that may be presented or otherwise provided within the dashboard GUI display 304 of FIG. 3 along the top of the display region 303 for defining and maintaining a dashboard filter in the on-demand application system 100. For example, in one or more embodiments, one or more of the GUI elements 500, 502, 504, 506 may be provided in lieu of one or more of the GUI elements 320, 322, 324, 326. However, in alternative embodiments, one or more of the GUI elements 500, 502, 504, 506 may be provided in addition to GUI elements 320, 322, 324, 326.

Referring to FIGS. 5-6, and with continued reference to FIGS. 1-4, the user of the client device 106 may manipulate the drop-down menu elements 500, 502, 504 to identify or otherwise define the desired filtering criteria for the dashboard filter, so that the resulting filtered report visualizations presented in the filtered dashboard GUI display 404 are indicative of report data that is based solely on object data associated with account objects having a value for their region field equal to United States (e.g., ‘US’) and a value for their industry field equal to software, i.e., visualizations of report data generated based on an organization's software accounts in the United States. As illustrated in FIG. 6, the user may manipulate GUI element 506 to indicate a desire to save, store, or otherwise maintain the dashboard filter in the database 104, wherein in response to receiving the indication, the application platform 112 and/or the virtual application 116 generates or otherwise provides a pop-up window 600 that includes a GUI element 602 (e.g., a checkbox) adapted to allow the user to designate the dashboard filter as a default (or pinned) dashboard filter along with another GUI element 604 (e.g., a text box) adapted to allow the user to provide an identifier for the dashboard filter. For the illustrated embodiment, after the user manipulates the GUI element 604 to provide a name for the dashboard filter and manipulates the GUI element 602 to designate the dashboard filter as a default dashboard filter, the application platform 112 and/or the virtual application 116 updates the tables 126, 128, 130 to store or otherwise maintain the filtering criteria indicated by the GUI elements 500, 502 in association with the filter identifier indicated by GUI element 604, indicate or otherwise identify the dashboard filter as the user's default dashboard filter, and store or otherwise maintain the filtered visualizations for that filter in the database 104.

Additionally, the stored dashboard filters in the filter table 128 that are associated with the user may be identified and utilized to populate a drop-down menu GUI element 508 that allows the user to select, from among his or her associated dashboard filters, which dashboard filter the user would like to apply to the dashboard currently being presented within the virtual application 116. Thereafter, the user may manipulate the GUI elements 500, 502, 504, 506 to modify or otherwise edit a pre-existing dashboard filter and/or designate another filter associated with the user as the default dashboard filter. In the illustrated embodiment of FIG. 6, after a user designates the dashboard filter as a favorite and a default dashboard view by manipulating GUI elements 506, 602, the application platform 112 and/or the virtual application 116 may automatically populate the drop-down menu GUI element 508 with the name of the dashboard filter indicated by GUI element 604 to indicate or otherwise identify that the current dashboard filter is now selected from among the stored dashboard filters in the filter table 128 that are associated with the user. In this regard, the filter indicated by the drop-down menu GUI element 508 may be applied to the current and/or subsequent dashboard GUI displays until the user manipulates the drop-down menu element 508 to select another dashboard filter or manipulates the drop-down menu elements 500, 502, 504 506 to modify the filtering criteria and/or create a new dashboard filter.

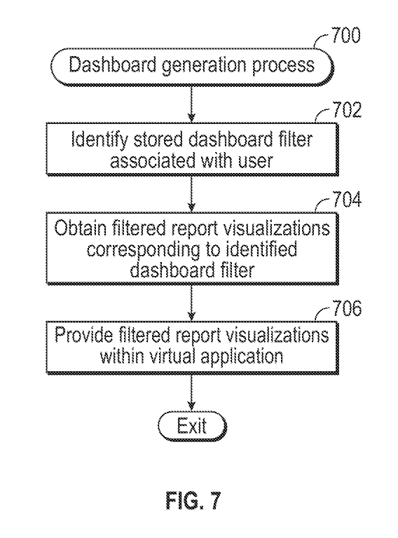

FIG. 7 depicts an exemplary embodiment of a dashboard generation process 700 suitable for implementation by an on-demand application system to generate a filtered dashboard within a virtual application. The various tasks performed in connection with the illustrated process 700 may be performed by software, hardware, firmware, or any combination thereof. For illustrative purposes, the following description may refer to elements mentioned above in connection with FIG. 1. In practice, portions of the dashboard generation process 700 may be performed by different elements of the on-demand application system 100, such as, for example, the application server 102, the database 104, the processing system 110, the application platform 112, the virtual application 116, and/or the application code 120. It should be appreciated that the dashboard generation process 700 may include any number of additional or alternative tasks, the tasks need not be performed in the illustrated order and/or the tasks may be performed concurrently, and/or the dashboard generation process 700 may be incorporated into a more comprehensive procedure or process having additional functionality not described in detail herein. Moreover, one or more of the tasks shown and described in the context of FIG. 7 could be omitted from a practical embodiment of the dashboard generation process 700 as long as the intended overall functionality remains intact.

Referring to FIG. 7, and with reference to FIGS. 1-6, in exemplary embodiments, the dashboard generation process 700 is performed by the application platform 112 and/or the virtual application 116 to present or otherwise provide a filtered dashboard GUI display corresponding to a stored dashboard filter that has previously been defined by a user and/or designated as a default dashboard filter for the user. In exemplary embodiments, when the dashboard tab 302 is selected or otherwise activated after a user of a client device 106 logs in to the virtual application 116, the application platform 112 and/or the virtual application 116 automatically identifies a stored dashboard filter associated with the user of the client device 106 to be applied to the dashboard, retrieves or otherwise obtains the filtered report visualizations corresponding to the identified dashboard filter from the database 104, and automatically presents or otherwise provides a filtered dashboard GUI display within the virtual application 116 that includes the filtered report visualizations associated with the identified dashboard filter (tasks 702, 704, 706).

For example, referring to FIG. 4, after the user of the client device 106 has manipulated the button 326 to pin the dashboard filter, the application platform 112 and/or the virtual application 116 updates the user table 126 and/or the dashboard table 130 to indicate the dashboard filter defined by the filtering criteria from GUI elements 320, 322, 324 is the default dashboard filter for the user. Thereafter, the user may log out of the virtual application 116 and subsequently log back in to the virtual application 116 and select the dashboard tab 302 to view his or her dashboards. In response to the dashboard tab 302 being selected or otherwise activated, the application platform 112 and/or the virtual application 116 accesses the user table 126 and/or the dashboard table 130 to identify a dashboard associated with the user for presentation. In this regard, in response to the application platform 112 and/or the virtual application 116 identifying the default dashboard associated with the user, the application platform 112 and/or the virtual application 116 automatically obtains the stored report visualizations 410, 412, 414 from the database 104 and generates or otherwise provides the filtered dashboard GUI display 404 in the display region 303. Additionally, the application platform 112 and/or the virtual application 116 may obtain the filtering criteria associated with the default dashboard filter from the filter table 128 in the database 104 and automatically populate the GUI elements 320, 322, 324 such that they indicate the filtering criteria for the corresponding to the filtered dashboard GUI display 404 currently being presented. In this manner, the default (or pinned) dashboard filter may be persisted in the database 104 so that the corresponding filtered dashboard GUI display 404 is automatically presented when the dashboard tab 302 is activated without any additional manual interaction by the user (e.g., the user does not need to manipulate the GUI elements 320, 322, 324 to achieve the filtered dashboard GUI display 404).

In a similar manner, when the dashboard display region 303 includes a GUI element 508 that allows the user to select among multiple different stored dashboard filters, in response to the user of the client device 106 manipulating the GUI element 508 to select a different dashboard filter, the application platform 112 and/or the virtual application 116 accesses the database 104 to identify the selected dashboard associated with the user for presentation, obtain the stored report visualizations associated with the selected dashboard from the database 104, and automatically generate or otherwise provide the filtered dashboard GUI display including the stored report visualizations associated with the selected dashboard within the dashboard display region 303. Again, the selected stored dashboard filter is persisted in the database 104 so that the corresponding filtered dashboard GUI display can be without the user manipulating GUI elements to redefine the filtering criteria each time the user wants to apply a particular dashboard filter.

It should be noted that in some embodiments, a stored dashboard filter associated with a user may be applied across multiple different dashboards. For example, the dashboard table 130 may maintain a plurality of different dashboards for a user's tenant, wherein each of the different dashboards includes a different set of report visualizations. After a user has defined a dashboard filter and pinned the dashboard filter to the dashboard GUI display or designated that dashboard filter as a default dashboard filter, when the user selects from among the different dashboards associated with that user and/or tenant, the application platform 112 and/or the virtual application 116 automatically applies the default dashboard filter to obtain the set of filtered report visualizations corresponding to the selected dashboard. For example, referring again to FIGS. 3-4, the tenant associated with the user of the client device 106 may have multiple different sets of report visualizations maintained in the dashboard table 130, such as, for example, a company performance dashboard having a first set of report visualizations based on that tenant's report data in the report table 124 across the entire company and a division performance dashboard having a second set of report visualizations based on that tenant's sales report data in the report table 124 for a particular division of the company.

When the user logs in to the virtual application 116 and selects the dashboard tab 302, the filtered company performance dashboard GUI display 404 may automatically be presented in the dashboard display region 303 by virtue of the dashboard filter having the filtering criteria indicated by GUI elements 320, 322, 324 being pinned as the user's default dashboard filter. Thereafter, the user may manipulate a GUI element 306 to select the division performance dashboard, and in response, the application platform 112 and/or the virtual application 116 automatically updates the display region 303 to include the filtered set of report visualizations based on the tenant's sales report data in the report table 124 for a division of the company. In this regard, in response to receiving indication of a selected dashboard via the GUI element 306, the application platform 112 and/or the virtual application 116 accesses the database 104 to identify the default dashboard filter for the user and determine whether a set of filtered report visualizations associated with the selected dashboard and the identified default dashboard filter is stored or otherwise maintained in the database 104. When a set of filtered report visualizations associated with the selected dashboard and the identified default dashboard filter is stored in the database 104, the application platform 112 and/or the virtual application 116 automatically obtains those stored filtered report visualizations from the database 104 and presents or otherwise provides those stored filtered report visualizations corresponding to the division performance dashboard within the dashboard display region 303. Alternatively, if a set of filtered report visualizations associated with the selected dashboard and the identified default dashboard filter is not stored in the database 104, the application platform 112 and/or the virtual application 116 automatically obtains the division report data from the report table 124 for generating the set of report visualizations for the division performance dashboard, applies the filtering criteria for the default (or pinned) dashboard filter to obtain a filtered subset of the division report data, generates the filtered report visualizations based on the filtered division report data, and presents or otherwise provides those filtered report visualizations within the dashboard display region 303. In this manner, a default (or pinned) dashboard filter may automatically be applied across different dashboards that are associated with or otherwise accessible to the user without the user having to manually define the filtering criteria and manually indicate a desire to apply the filtering criteria when the user is selecting among multiple different dashboards for display.

FIG. 8 depicts an exemplary embodiment of a multi-tenant system 800 suitable for use as the on-demand application system 100 of FIG. 1. The illustrated multi-tenant system 800 of FIG. 8 includes a server 802 (e.g., application server 102) that dynamically creates and supports virtual applications 828 (e.g., virtual application 116) based upon data 832 from a common database 830 (e.g., database 104) that is shared between multiple tenants, alternatively referred to herein as a multi-tenant database. Data and services generated by the virtual applications 828 are provided via a network 845 (e.g., network 108) to any number of client devices 840 (e.g., client device 106, or the like), as desired. Each virtual application 828 is suitably generated at run-time (or on-demand) using a common application platform 810 (e.g., application platform 112) that securely provides access to the data 832 in the database 830 for each of the various tenants subscribing to the multi-tenant system 800. In accordance with one non-limiting example, the multi-tenant system 800 is implemented in the form of an on-demand multi-tenant customer relationship management (CRM) system that can support any number of authenticated users of multiple tenants.

As used herein, a “tenant” or an “organization” should be understood as referring to a group of one or more users that shares access to common subset of the data within the multi-tenant database 830. In this regard, each tenant includes one or more users associated with, assigned to, or otherwise belonging to that respective tenant. To put it another way, each respective user within the multi-tenant system 800 is associated with, assigned to, or otherwise belongs to a particular tenant of the plurality of tenants supported by the multi-tenant system 800. Tenants may represent customers, customer departments, business or legal organizations, and/or any other entities that maintain data for particular sets of users within the multi-tenant system 800 (i.e., in the multi-tenant database 830). For example, the application server 802 may be associated with one or more tenants supported by the multi-tenant system 800. Although multiple tenants may share access to the server 802 and the database 830, the particular data and services provided from the server 802 to each tenant can be securely isolated from those provided to other tenants (e.g., by restricting other tenants from accessing a particular tenant's data using that tenant's unique organization identifier as a filtering criterion). The multi-tenant architecture therefore allows different sets of users to share functionality and hardware resources without necessarily sharing any of the data 832 belonging to or otherwise associated with other tenants.

The multi-tenant database 830 is any sort of repository or other data storage system capable of storing and managing the data 832 associated with any number of tenants. The database 830 may be implemented using any type of conventional database server hardware. In various embodiments, the database 830 shares processing hardware 804 with the server 802. In other embodiments, the database 830 is implemented using separate physical and/or virtual database server hardware that communicates with the server 802 to perform the various functions described herein. In an exemplary embodiment, the database 830 includes a database management system or other equivalent software capable of determining an optimal query plan for retrieving and providing a particular subset of the data 832 to an instance of virtual application 828 in response to a query initiated or otherwise provided by a virtual application 828. The multi-tenant database 830 may alternatively be referred to herein as an on-demand database, in that the multi-tenant database 830 provides (or is available to provide) data at run-time to on-demand virtual applications 828 generated by the application platform 810.

In practice, the data 832 may be organized and formatted in any manner to support the application platform 810. In various embodiments, the data 832 is suitably organized into a relatively small number of large data tables to maintain a semi-amorphous “heap”-type format. The data 832 can then be organized as needed for a particular virtual application 828. In various embodiments, conventional data relationships are established using any number of pivot tables 834 that establish indexing, uniqueness, relationships between entities, and/or other aspects of conventional database organization as desired. Further data manipulation and report formatting is generally performed at run-time using a variety of metadata constructs. Metadata within a universal data directory (UDD) 836, for example, can be used to describe any number of forms, reports, workflows, user access privileges, business logic and other constructs that are common to multiple tenants. Tenant-specific formatting, functions and other constructs may be maintained as tenant-specific metadata 838 for each tenant, as desired. Rather than forcing the data 832 into an inflexible global structure that is common to all tenants and applications, the database 830 is organized to be relatively amorphous, with the pivot tables 834 and the metadata 838 providing additional structure on an as-needed basis. To that end, the application platform 810 suitably uses the pivot tables 834 and/or the metadata 838 to generate “virtual” components of the virtual applications 828 to logically obtain, process, and present the relatively amorphous data 832 from the database 830.

The server 802 is implemented using one or more actual and/or virtual computing systems that collectively provide the dynamic application platform 810 for generating the virtual applications 828. For example, the server 802 may be implemented using a cluster of actual and/or virtual servers operating in conjunction with each other, typically in association with conventional network communications, cluster management, load balancing and other features as appropriate. The server 802 operates with any sort of conventional processing hardware 804, such as a processor 805, memory 806, input/output features 807 and the like. The input/output features 807 generally represent the interface(s) to networks (e.g., to the network 845, or any other local area, wide area or other network), mass storage, display devices, data entry devices and/or the like. The processor 805 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 806 represents any non-transitory short or long term storage or other computer-readable media capable of storing programming instructions for execution on the processor 805, including any sort of random access memory (RAM), read only memory (ROM), flash memory, magnetic or optical mass storage, and/or the like. The computer-executable programming instructions, when read and executed by the server 802 and/or processor 805, cause the server 802 and/or processor 805 to create, generate, or otherwise facilitate the application platform 810 and/or virtual applications 828 and perform one or more additional tasks, operations, functions, and/or processes described herein. It should be noted that the memory 806 represents one suitable implementation of such computer-readable media, and alternatively or additionally, the server 802 could receive and cooperate with external computer-readable media that is realized as a portable or mobile component or application platform, e.g., a portable hard drive, a USB flash drive, an optical disc, or the like.

The application platform 810 is any sort of software application or other data processing engine that generates the virtual applications 828 that provide data and/or services to the client devices 840. In a typical embodiment, the application platform 810 gains access to processing resources, communications interfaces and other features of the processing hardware 804 using any sort of conventional or proprietary operating system 808. The virtual applications 828 are typically generated at run-time in response to input received from the client devices 840. For the illustrated embodiment, the application platform 810 includes a bulk data processing engine 812, a query generator 814, a search engine 816 that provides text indexing and other search functionality, and a runtime application generator 820. Each of these features may be implemented as a separate process or other module, and many equivalent embodiments could include different and/or additional features, components or other modules as desired.

The runtime application generator 820 dynamically builds and executes the virtual applications 828 in response to specific requests received from the client devices 840. The virtual applications 828 are typically constructed in accordance with the tenant-specific metadata 838, which describes the particular tables, reports, interfaces and/or other features of the particular application 828. In various embodiments, each virtual application 828 generates dynamic web content that can be served to a browser or other client program 842 associated with its client device 840, as appropriate.

The runtime application generator 820 suitably interacts with the query generator 814 to efficiently obtain multi-tenant data 832 from the database 830 as needed in response to input queries initiated or otherwise provided by users of the client devices 840. In a typical embodiment, the query generator 814 considers the identity of the user requesting a particular function (along with the user's associated tenant), and then builds and executes queries to the database 830 using system-wide metadata 836, tenant specific metadata 838, pivot tables 834, and/or any other available resources. The query generator 814 in this example therefore maintains security of the common database 830 by ensuring that queries are consistent with access privileges granted to the user and/or tenant that initiated the request. In this manner, the query generator 814 suitably obtains requested subsets of data 832 accessible to a user and/or tenant from the database 830 as needed to populate the tables, reports or other features of the particular virtual application 828 for that user and/or tenant.

Still referring to FIG. 8, the data processing engine 812 performs bulk processing operations on the data 832 such as uploads or downloads, updates, online transaction processing, and/or the like. In many embodiments, less urgent bulk processing of the data 832 can be scheduled to occur as processing resources become available, thereby giving priority to more urgent data processing by the query generator 814, the search engine 816, the virtual applications 828, etc.

In exemplary embodiments, the application platform 810 is utilized to create and/or generate data-driven virtual applications 828 for the tenants that they support. Such virtual applications 828 may make use of interface features such as custom (or tenant-specific) screens 824, standard (or universal) screens 822 or the like. Any number of custom and/or standard objects 826 may also be available for integration into tenant-developed virtual applications 828. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system. For example, a virtual CRM application may utilize standard objects 826 such as “account” objects, “opportunity” objects, “contact” objects, or the like. The data 832 associated with each virtual application 828 is provided to the database 830, as appropriate, and stored until it is requested or is otherwise needed, along with the metadata 838 that describes the particular features (e.g., reports, tables, functions, objects, fields, formulas, code, etc.) of that particular virtual application 828. For example, a virtual application 828 may include a number of objects 826 accessible to a tenant, wherein for each object 826 accessible to the tenant, information pertaining to its object type along with values for various fields associated with that respective object type are maintained as metadata 838 in the database 830. In this regard, the object type defines the structure (e.g., the formatting, functions and other constructs) of each respective object 826 and the various fields associated therewith.

Still referring to FIG. 8, the data and services provided by the server 802 can be retrieved using any sort of personal computer, mobile telephone, tablet or other network-enabled client device 840 on the network 845. In an exemplary embodiment, the client device 840 includes a display device, such as a monitor, screen, or another conventional electronic display capable of graphically presenting data and/or information retrieved from the multi-tenant database 830. Typically, the user operates a conventional browser application or other client program 842 executed by the client device 840 to contact the server 802 via the network 845 using a networking protocol, such as the hypertext transport protocol (HTTP) or the like. The user typically authenticates his or her identity to the server 802 to obtain a session identifier (“SessionID”) that identifies the user in subsequent communications with the server 802. When the identified user requests access to a virtual application 828, the runtime application generator 820 suitably creates the application at run time based upon the metadata 838, as appropriate. As noted above, the virtual application 828 may contain Java, ActiveX, or other content that can be presented using conventional client software running on the client device 840; other embodiments may simply provide dynamic web or other content that can be presented and viewed by the user, as desired.

The foregoing description is merely illustrative in nature and is not intended to limit the embodiments of the subject matter or the application and uses of such embodiments. Furthermore, there is no intention to be bound by any expressed or implied theory presented in the technical field, background, or the detailed description. As used herein, the word “exemplary” means “serving as an example, instance, or illustration.” Any implementation described herein as exemplary is not necessarily to be construed as preferred or advantageous over other implementations, and the exemplary embodiments described herein are not intended to limit the scope or applicability of the subject matter in any way.

For the sake of brevity, conventional techniques related to multi-tenancy, cloud computing, on-demand applications, and other functional aspects of the systems (and the individual operating components of the systems) may not be described in detail herein. In addition, those skilled in the art will appreciate that embodiments may be practiced in conjunction with any number of system and/or network architectures, data transmission protocols, and device configurations, and that the system described herein is merely one suitable example. Furthermore, certain terminology may be used herein for the purpose of reference only, and thus is not intended to be limiting. For example, the terms “first”, “second” and other such numerical terms do not imply a sequence or order unless clearly indicated by the context.

Embodiments of the subject matter may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processing systems or devices can carry out the described operations, tasks, and functions by manipulating electrical signals representing data bits at accessible memory locations, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any non-transitory medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like. In this regard, the subject matter described herein can be implemented in the context of any computer-implemented system and/or in connection with two or more separate and distinct computer-implemented systems that cooperate and communicate with one another. In one or more exemplary embodiments, the subject matter described herein is implemented in conjunction with a virtual customer relationship management (CRM) application in a multi-tenant environment.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application. Accordingly, details of the exemplary embodiments or other limitations described above should not be read into the claims absent a clear intention to the contrary.

What is claimed is:

1. A method of providing report visualizations in an on-demand system providing instances of a virtual application over a network, the method comprising:
identifying a filter associated with a user of a client device on the network; and
automatically providing one or more filtered report visualizations within an instance of the virtual application on the client device in response to identifying the filter associated with the user, wherein each visualization of the one or more filtered report visualizations comprises a graphical representation of a filtered subset of report data that satisfies the filter.

2. The method of claim 1, wherein identifying the filter comprises identifying a default filter associated with the user in a database.

3. The method of claim 2, further comprising providing, by an application server coupled to the database, the instance of the virtual application on the client device, wherein in response to activation of a graphical user interface element within the instance of the virtual application indicative of a desire to view the report visualizations, the application server identifies the default filter associated with the user and automatically provides the one or more filtered report visualizations within the instance of the virtual application on the client device.

4. The method of claim 1, wherein automatically providing the one or more filtered report visualizations comprises:
obtaining, from a database by an application server providing the instance of the virtual application on the client device, the one or more filtered report visualizations stored by the database based on an association between the filter and the one or more filtered report visualizations maintained by the database; and
automatically providing, by the application server, the one or more filtered report visualizations obtained from the database within the instance of the virtual application on the client device.

5. The method of claim 1, wherein automatically providing the one or more filtered report visualizations comprises:
identifying, by an application server providing the instance of the virtual application on the client device, one or more filtering criteria associated with the filter;
obtaining, by the application server, the report data from a database;
applying, by the application server, the one or more filtering criteria to the report data to exclude at least a portion of the report data, resulting in the filtered subset of the report data that satisfies the one or more filtering criteria;
generating, by the application server, the one or more filtered report visualizations based on the filtered subset of the report data; and
providing, by the application server, the one or more filtered report visualizations within the instance of the virtual application on the client device.

6. The method of claim 1, further comprising:
providing one or more graphical user interface elements for defining one or more filtering criteria for the filter, the filtered subset of the report data satisfying the one or more filtering criteria indicated by the one or more graphical user interface elements; and
providing a graphical user interface element for persisting the filter within the on-demand system.

7. The method of claim 6, further comprising maintaining an association between the filter and the user in a database in response to manipulation of the graphical user interface element.

8. The method of claim 7, wherein:
an application server coupled to the database provides the instance of the virtual application on the client device; and
identifying the filter comprises the application server identifying the filter based on the association between the filter and the user in the database.

9. The method of claim 8, further comprising maintaining the one or more filtered report visualizations in the database in response to the manipulation of the graphical user interface element, wherein automatically providing the one or more filtered report visualizations comprises the application server obtaining the one or more filtered report visualizations from the database in response to identifying the filter and automatically providing the one or more filtered report visualizations obtained from the database within the instance of the virtual application.

10. The method of claim 1, the one or more filtered report visualizations corresponding to a first dashboard, the first dashboard comprising one or more report visualizations based on the report data, the one or more filtered report visualizations corresponding to the one or more report visualizations, the method further comprising:
providing a graphical user interface element within the instance of the virtual application for selecting a second dashboard, the second dashboard comprising a second set of one or more report visualizations based on second report data; and
in response to selection of the second dashboard, automatically providing a second set of one or more filtered report visualizations within the instance of the virtual application, wherein each visualization of the second set comprises a graphical representation of a filtered subset of the second report data that satisfies the filter.

11. A method of presenting a dashboard in a multi-tenant system including an application server providing instances of a virtual application over a network to a plurality of tenants, the dashboard including a set of report visualizations comprising graphical representations of report data from one or more reports, the method comprising:
accessing, by the application server, a database coupled to the application server to identify an association between a dashboard filter and a user of a client device on the network; and
in response to identifying the association, automatically providing, by the application server, a dashboard display within an instance of the virtual application on the client device that includes a filtered set of the report visualizations, wherein the report visualizations of the filtered set comprise graphical representations of filtered report data from the one or more reports, the filtered report data comprising a subset of the report data that satisfies the dashboard filter.

12. The method of claim 11, further comprising providing a tab menu within the instance of the virtual application, the tab menu including a dashboard tab, wherein the application server accesses the database to identify the association in response to activation of the dashboard tab.

13. The method of claim 11, wherein accessing the database comprises the application server accessing the database to identify a default dashboard filter associated with the user in response to the user logging in to the instance of the virtual application.

14. The method of claim 13, further comprising:
providing a graphical user interface element for pinning the dashboard filter to the dashboard display; and
maintaining the association between the dashboard filter and the user in the database in response to manipulation of the graphical user interface element.

15. The method of claim 14, further comprising maintaining the graphical representations of the filtered report data in the database in response to the manipulation of the graphical user interface element.

16. The method of claim 14, further comprising:
providing one or more graphical user interface elements for defining one or more filtering criteria for the dashboard filter, the filtered report data satisfying the one or more filtering criteria indicated by the one or more graphical user interface elements; and
maintaining the graphical representations of the filtered report data in the database in response to the manipulation of the graphical user interface element.

17. The method of claim 11, further comprising:
providing a graphical user interface element within the instance of the virtual application for selecting a second dashboard for presentation, the second dashboard including a second set of report visualizations comprising graphical representations of second report data; and
in response to selection of the second dashboard, automatically providing, by the application server, a second dashboard display within the instance of the virtual application that includes a second filtered set of the report visualizations, wherein the report visualizations of the second filtered set comprise graphical representations of a subset of the second report data that satisfies the dashboard filter.

18. A system comprising:
a database to maintain an association between a user and a filter and report data for one or more reports; and
a server coupled to the database, wherein the server is coupled to a network to provide an instance of a virtual application to a client device associated with the user, accessing the database to identify the association between the filter and the user of the client device, and automatically provide a dashboard display that includes a filtered set of the report visualizations within the instance of the virtual application in response to identifying the association, wherein the report visualizations of the filtered set comprise graphical representations generated of filtered report data, the filtered report data comprising a subset of the report data that satisfies the filter.

19. The system of claim 18, wherein:
the virtual application comprises a customer relationship management (CRM) application provided to a plurality of tenants;
the user is associated with a first tenant of the plurality of tenants;
the one or more reports are associated with the first tenant; and
the filtered report data comprises a subset of the report data that satisfies one or more filtering criteria associated with the filter.

20. The system of claim 18, the database maintaining the filtered set of the report visualizations, wherein in response to identifying the association between the filter and the user, the server is configured to obtain the filtered set of the report visualizations from the database and automatically provide the filtered set of the report visualizations obtained from the database within the instance of the virtual application.
